(19) United States
(12) Patent Application Publication
(10) Pub. No.: US 2003/0200445 A1
(43) Pub. Date: Oct. 23, 2003

(54) Secure computer system using SIM card and control method thereof

(75) Inventor: Kyun-hoe Park, Suwon City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon city (KR)

(21) Appl. No.: 10/237,749

(22) Filed: Sep. 10, 2002

(30) Foreign Application Priority Data
Apr. 18, 2002 (KR) 2002-21235

(51) Int. Cl. H04L 9/00

(52) U.S. Cl. 713/185; 713/202

(57) ABSTRACT

A computer system is secured by providing a SIM card storing user identification information and a communication module accessing a network with the user identification information stored in the SIM card. A password storage stores the user identification information from the SIM card and a controller allows a user to access the computer system when the computer system is booted if the user identification information stored in the SIM card is identical to the user identification information stored in the password storage, thereby allowing user identification information stored in the SIM card, which is used to access the network, to also be employed as a password for the computer system.

### CROSS-REFERENCE TO RELATED APPLICATIONS

This application claims the benefit of Korean Application No. 2002-21235 filed Apr. 18, 2002, in the Korean Intellectual Property Office, the disclosure of which is incorporated herein by reference.

### BACKGROUND OF THE INVENTION

1. Field of the Invention

The present invention relates to a secure computer system using a SIM (subscriber identity module) card and a security control method thereof, and more particularly, to a secure computer system using a SIM card and a security control method thereof, in which user identification information stored in a SIM card is used as a password for accessing a computer system.

2. Description of the Related Art

There are various security methods to protect confidential information stored in a computer system. For instance, typically computer systems are protected by a password which is set up through a BIOS (basic input/output system) setup menu and stored in a CMOS (complementary metal oxide semiconductor) RAM (random access memory) or a hard disk. However, security methods using the CMOS RAM or the hard disk can allow an anonymous proficient user to gain illegal access to the computer system without difficulty.

To strengthen security of a computer system, there has been proposed other security methods using bio-information, such as a fingerprint, etc., an IC (integrated circuit) card, a magnetic card, a PC (personal computer) card, etc.

In the case of the security method using bio-information, such as fingerprints, an iris, etc., although security of the computer system is strengthened because individual characteristics of a user are employed as password(s), such a security method requires expensive equipment.

In the case of the security method using the IC card, the magnetic card, the PC card, etc., a user has to buy these cards separately, which can be uneconomical and cumbersome. Further, the password stored in each card is not based upon individual characteristics of a user, but voluntary information set up by a user or a card supplier, so that the password employed for verifying a user's identity has relatively low reliability. Particularly, in the case of the PC card, if the PC card remains attached to the computer system, anyone can access and change data stored in the PC card.

On the other hand, there is GSM (global system for mobile communications) as a wireless communication standard for Europe and America, which allows a user to access and use a wireless communication system anywhere in Europe and America. To use the wireless communication system according to the GSM, a user has to be issued a SIM card storing user identification information, and the user inserts the SIM card in a portable telephone for the GSM. The SIM card is detachably inserted in the portable telephone, and a user can access the wireless communication system with the user identification information stored in the SIM card.

The user identification information stored in the SIM card is employed for authenticating a registered user and preventing an unregistered user from illegally accessing the wireless communication system. Further, typically, the user identification information stored in the SIM card is thoroughly protected from disclosure/recovery to/by a third party, thereby preventing, for example, wiretapping and access to the user's identification information.

### SUMMARY OF THE INVENTION

Accordingly, an object of the present invention is to provide a secure computer system using a SIM card and a security control method thereof, which provides inexpensive and superior computer security.

Additional objects and advantages of the invention will be set forth in part in the description which follows and, in part, will be obvious from the description, or may be learned by practice of the invention.

The present invention may be achieved by providing a computer system comprising a SIM card storing user identification information; a communication module accessing a network with the user identification information stored in the SIM card; a password storage storing the user identification information; and a controller allowing a user to access the computer system upon booting of the computer system when the user identification information stored in the SIM card is identical to the user identification information stored in the password storage.

In an aspect of the invention, the secure computer system comprises a SIM card reader to which the SIM card is inserted; and a remote interface transmitting the user identification information from the SIM card reader to the communication module according to control of the controller, and wherein the controller reads the user identification information from the SIM card inserted in the SIM card reader through the remote interface, and allows a user to access the computer system upon booting of the computer system when the user identification information stored in the SIM card is identical to the user identification information stored in the password storage.

In an aspect of the invention, the communication module includes a card connector to which the SIM card is detachably connected.

According to another aspect of the present invention, the present invention may also be achieved by providing a method of controlling security of a computer system, comprising storing user identification information from a SIM card that is used to access a network; reading the user identification information from the SIM card when the computer system is turned on or booted; determining whether the user identification information stored in the SIM card is identical to the stored user identification information; and allowing a user to access the computer system when the user identification information stored in the SIM card is identical to the stored user identification information.

In an aspect of the invention, the security method further comprises determining whether the SIM card is connected to the computer system; and informing a user of absence of the SIM card when the SIM card is not connected to the computer system.

### BRIEF DESCRIPTION OF THE DRAWINGS

These and other objects and advantages of the present invention will become apparent and more readily appreciated from the following description of the embodiments, taken in conjunction with the accompany drawings of which:

FIG. 1 is a control block diagram of a computer system according to an embodiment of the present invention;

FIG. 2 is a control block diagram illustrating a computer system according to another embodiment of the present invention;

FIG. 3 is a control block diagram illustrating a computer system according to another embodiment of the present invention;

FIG. 4 is a flowchart of setting up a password for a computer system according to the present invention; and

FIG. 5 is a flowchart of controlling security of a computer system according to the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

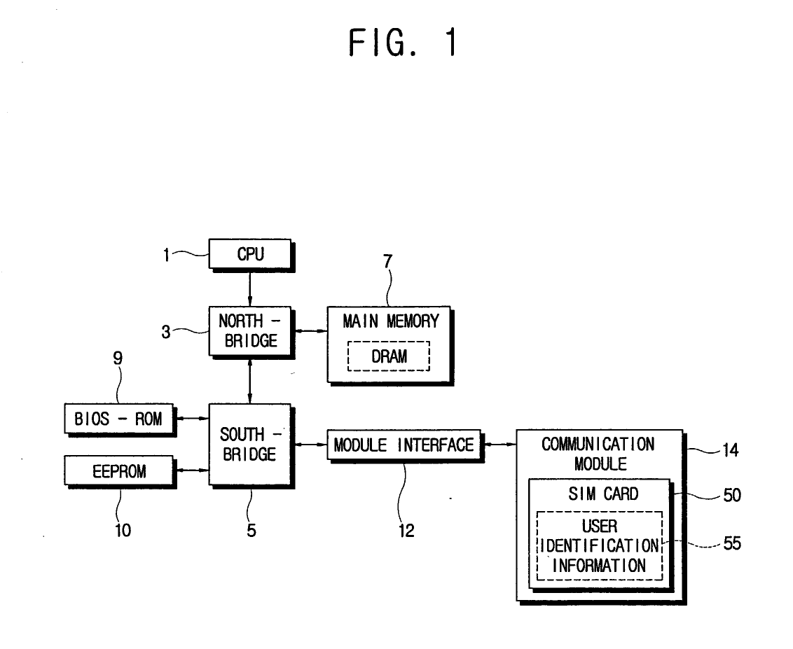

FIG. 1 is a control block diagram of a computer system with a security system according to the present invention. As shown therein, the computer system comprises a CPU (central processing unit) 1, a main memory 7, including a DRAM (dynamic random access memory), a BIOS-ROM 9 (basic input/output system—read only memory) storing a BIOS, a north-bridge 3, a south-bridge 5, an EEPROM (electrically erasable programmable read only memory) 10 storing user identification information, a module interface 12, a communication module 14 connected to the module interface 12, and a SIM card 50 storing user identification information 55 and being mounted on the communication module 14.

Typically, the north-bridge 3 is a chipset performing data transmission among the CPU 1, the main memory 7 and a graphic card (not shown). Typically, the south-bridge 5 is a chipset performing data transmission among other components of the system, such as internal and/or external peripheral devices, except the components whose data transmission is performed by the north-bridge 3. That is, typically the south-bridge 5 performs data transmission of the module interfaces 12, such as a PCI (peripheral component interconnect) interface, a PCMCIA (personal computer memory card international association) interface, a USB (universal serial bus) interface, an ISA (industry standard architecture) interface, etc.

In FIG. 1, the communication module 14 connected to the module interface 12 is typically a wireless modem accessing Internet through a GSM network. However, the communication module 14 can be any communication module capable of wirelessly communicating with other devices and/or networks using GSM networking. For instance, a CDMA (code division multiple access) network a communication module compatible with the GSM network is being developed, which can be used as the communication module 14.

In FIG. 1, the communication module 14 is mounted with the SIM card 50 storing user identification information 55 for authentication. Herein, the user identification information 55 stored in the SIM card 50 is employed not only to verify a user's identity when a user accesses a communication network but also as a password to access the computer system.

The BIOS stored in the BIOS-ROM 9 as a command code determines whether devices of the computer system are operating normally, and performs a POST (power on self test) procedure for loading an OS (operating system) from a hard disk into the main memory 7. Because typically the BIOS contains a security routine, the BIOS can determine whether the user identification information 55 stored in the SIM card 50 is identical to the user identification information stored in the EEPROM 10, perform the POST procedure, and allow a user to access the computer system only when the user identification information 55 in the SIM card 50 is identical to the user identification information in the EEPROM 10.

In FIG. 1, the user identification information compared with the user identification information 55 stored in the SIM card 50 may be stored in a CMOS-RAM, the hard disk, etc., instead of the EEPROM 10.

In FIG. 1, according to the present invention, when the south-bridge 5, the north-bridge 3 and the CPU 1 are set up in sequence and the BIOS stored in the BIOS-ROM 9 performs the POST procedure when the computer system is turned on/rebooted, it is determined (for example, by software as part of the BIOS) whether the user identification information 55 stored in the SIM card 50 is identical to the user identification information stored in the EEPROM 10, thereby allowing a user to access the computer system only when the user identification information 55 in the SIM card 50 is identical to the user identification information in the EEPROM 10. Processes of the invention as a security controller can be embodied in software and/or hardware, for example, as part of northbridge 3, southbridge 5, BIOS 9 and/or EEPROM 10 and executed on computer systems 1, 4 and/or 6, using known techniques.

The module interface 12 and the communication module 14 of the computer system according to the present invention can be applied to any computer system having a communication module mounted with a SIM CARD.

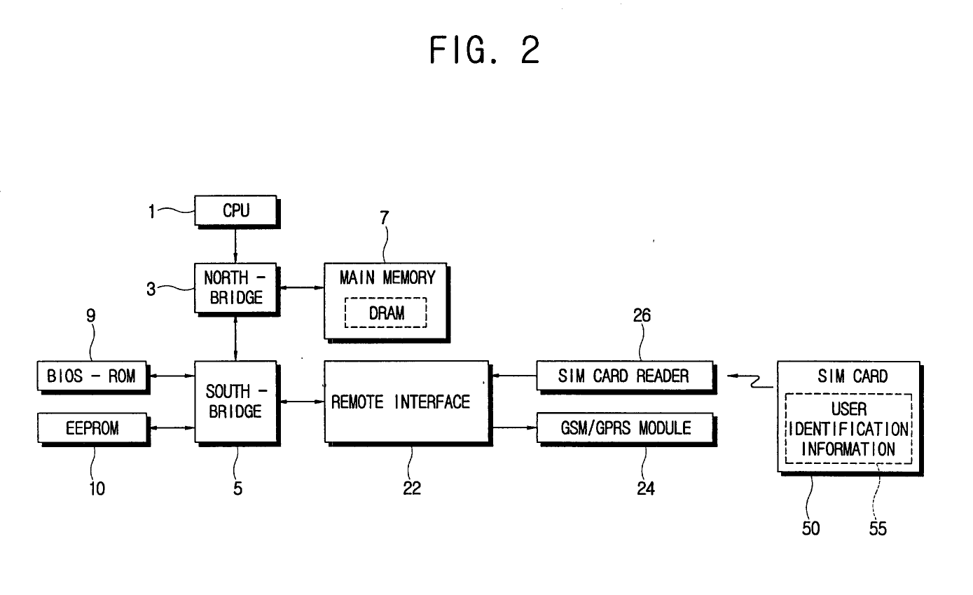

FIG. 2 is a control block diagram illustrating a secure computer system according to another embodiment of the present invention. Hereinbelow, repetitive descriptions about like elements described above will be avoided as necessary.

In FIG. 2, the secure computer system comprises a GSM/GPRS (global system for mobile communication/general packet radio services) module 24 mounted in a main body of a portable computer system, a SIM card reader 26 to which the SIM card 50 is inserted, and a remote interface 22 transmitting data from the SIM card reader 26 to the south-bridge 5 or the GSM/GPRS module 24.

In FIG. 2, the SIM card reader 26 is provided in the main body of the portable computer system, and the SIM card 50 is inserted in the SIM card reader 26. When the SIM card 50 is inserted in the SIM card reader 26, the SIM card reader 26 transmits a card connection signal to the remote interface 22, and the SIM card reader 26 reads data from the SIM card 50 according to a control signal transmitted from the remote interface 22.

In FIG. 2, the GSM/GPRS module 24 is a modem accessing the GSM network using the SIM card 50, and is mounted in the main body of the portable computer 4. Through the GSM/GPRS module 24, user identification information 55 stored in the SIM card 50 is transmitted to the GSM network so as to authenticate the user's identity for accessing the GSM network. On the other hand, there is being developed technology that a user identification card, such as the SIM card 50, is applied to a CDMA module that is compatible with the GSM network, and therefore the modem 24 mounted in the main body may be a CDMA module.

In FIG. 2, the south-bridge 5 controls the remote interface 22 as an interface between the SIM card 50 and the GSM/GPRS module 24 or between the SIM card 50 and the south-bridge 5. That is, if the portable computer system requires a password while being booted (e.g., computer 4 turned on or rebooted), the remote interface 22 reads the user identification information 55 stored in the SIM card 50 from the SIM card reader 26 and transmits the user identification information 55 to the south-bridge 5, thereby allowing access to the computer system as described above with reference to FIG. 1 (i.e., determine whether the user identification information 55 stored in the SIM card 50 is identical to the user identification information stored in the EEPROM 10, allowing access responsive to a match). Further, when a user wants to access the GSM network through the GSM/GPRS module 24, the remote interface 22 reads the user identification information 55 stored in the SIM card 50 from the SIM card reader 26 and transmits the user identification information 55 to the GSM/GPRS module 24, thereby allowing access to the GSM network.

In FIG. 2, in the computer system mounted with the GSM/GPRS module 24, the SIM card 50 is inserted in the SIM card reader 26, and the user identification information 55 stored in the SIM card 50 is employed in accessing the computer system and/or the GSM network.

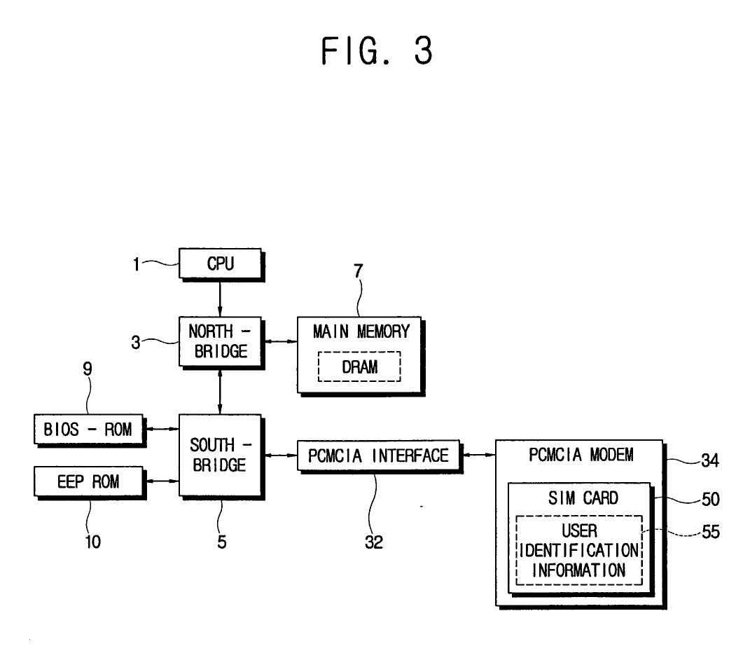

FIG. 3 is a control block diagram illustrating a secure computer system according to another example embodiment of the present invention using a PCMCIA interface 32 with a detachable (portable) communication module 14. Hereinbelow, repetitive descriptions about the like elements described above will be avoided as necessary.

In FIG. 3, the computer system comprises a PCMCIA interface 32 as the module interface 12 to be provided in the portable computer 6, and a detachable (portable) PCMCIA wireless modem 34, as the detachable communication module 14, which is in communication with the computer 6 via the PCMCIA interface 32.

The detachable PCMCIA wireless modem 34 accesses the GSM network, and is provided with a card groove (not shown) having a card connector (not shown) to which the SIM card 50 can be connected. The PCMCIA interface 32 controls peripheral devices attached to a PCMCIA slot, such as the detachable (portable) PCMCIA wireless modem 34, according to PCMCIA standards based upon a control signal transmitted from the southbridge 5.

In FIG. 3, when the south-bridge 5, the north-bridge 3 and the CPU 1 are set up in sequence and a POST procedure is performed when the computer system is turned on/rebooted, a user can access the computer system with the user identification information 55 stored in the SIM card 50 attached to the PCMCIA wireless modem 34, as described with reference to FIGS. 1 and 2.

In FIG. 3, the PCMCIA interface 32 is only an example peripheral device interface 12 typically currently used in computer systems. Therefore, various peripheral device interfaces 12 other than the PCMCIA interface 32, such as a PCI interface, a USB interface, an ISA interface, etc., can be employed in a computer to interface with any SIM card communication module 14 that provides the user identification information 55 stored in the SIM card 50.

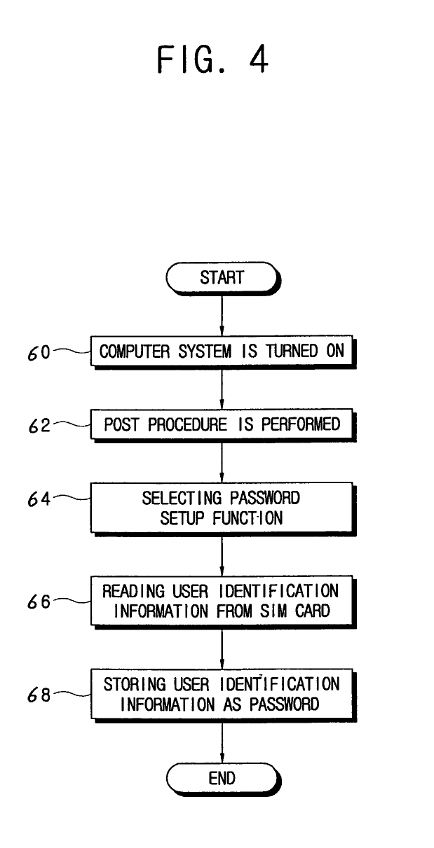

FIG. 4 is a flow chart of an example process setting up passwords in computer systems that are secured according to the present invention.

At operation 60, when a computer system of the present invention (e.g., systems 1, 4 and/or 6) is turned on/rebooted, the south-bridge 5, the north-bridge 3 and the CPU 1 are set up in sequence and at operation 62 the BIOS stored in the BIOS-ROM 9 performs the POST procedure. While the POST procedure is being performed at operation 62, a user at operation 64 selects a password setup function by using a setup key such as F2, etc. If at operation 64 the user selects a SIM card access function through the password setup function, at operation 66 the computer system reads the user identification information 55 from the SIM card 50. At operation 68, the user identification information 55 read from the SIM card 50 is stored in the EEPROM 10.

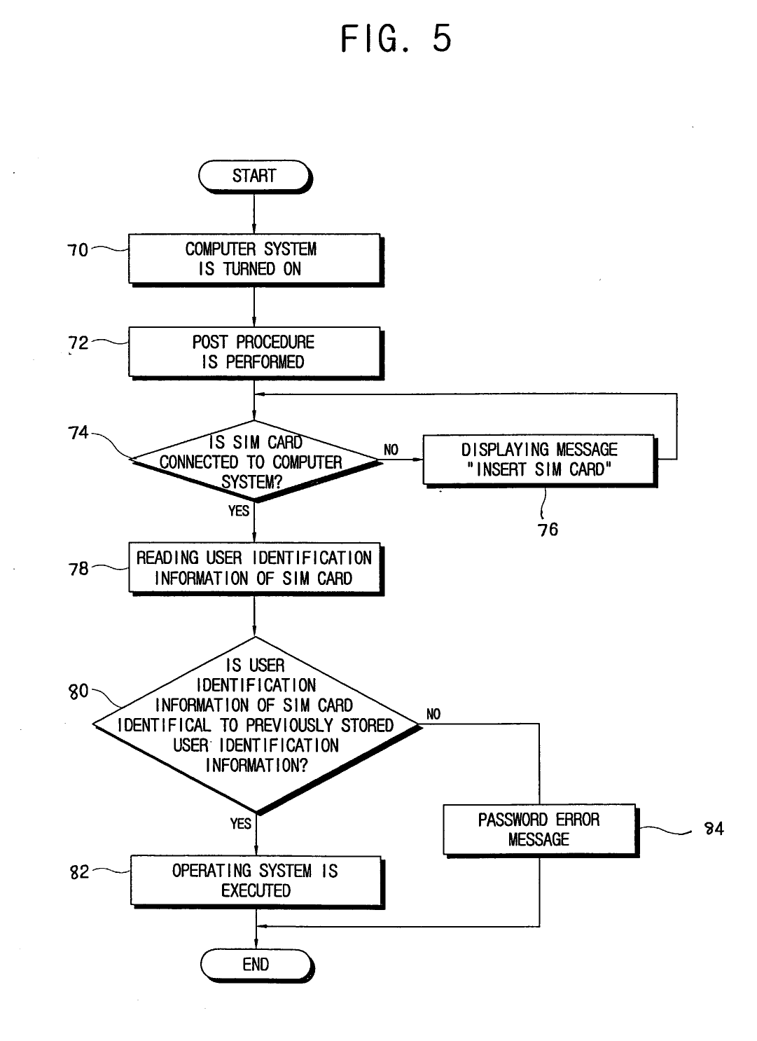

FIG. 5 is a flow chart of an example process controlling security of a computer system of the present invention after setting up (as described with reference to FIG. 4) the password with the user identification information 55 of the SIM card 50.

In FIG. 5 at operation 70, when a computer system of the present invention (e.g., systems 1, 4, and/or 6) is turned on/rebooted, the south-bridge 5, the north-bridge 3 and the CPU 1 are set up in sequence and at operation 72 the BIOS stored in the BIOS-ROM 9 performs the POST procedure. Because, typically the BIOS contains a security routine, at operation 74 the BIOS can determine whether the SIM card 50 for password authentication is connected to the computer system when performing the POST procedure. If at operation 74 the SIM card 50 is not connected to the computer system, at operation 76 the BIOS displays a message so as to make a user connect the SIM card 50 to the computer system.

If at operation 74 the SIM card 50 is connected to the computer system, at operation 78 the BIOS reads the user identification information 55 from the SIM card 50, and at operation 80 determines whether the user identification information 55 read from the SIM card 50 is identical to (matches/corresponds to) the user identification information previously stored in the EEPROM 10. At operation 80, when the user identification information 55 read from the SIM card 50 is identical to (matches/corresponds to) the user identification information previously stored in the EEPROM 10, at operation 82 an operating system is executed, thereby allowing a user to access the computer system.

Oppositely, at operation 80 when the user identification information 55 read from the SIM card 50 is not identical (does not match/does not correspond) to the user identification information previously stored in the EEPROM 10, at operation 84 a password error message is displayed, thereby protecting the computer system.

As described above, according to the present invention, the user identification information stored in a SIM card for mobile communications can be employed as the password of a computer system. Thus, a user can employ the user identification information of the SIM card, which has superior security, as the password for the computer system, thereby providing superior security for the computer system. As described above, the present invention provides a secure computer system using a SIM card and a security control method thereof, which provides inexpensive and superior security.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A secure computer system comprising:
a SIM card storing user identification information;
a communication module accessing a network with the user identification information stored in the SIM card;
a password storage storing the user identification information from the SIM card; and
a controller allowing a user to access the computer system upon booting of the computer system when the user identification information stored in the SIM card is identical to the user identification information stored in the password storage.

2. The computer system according to claim 1, further comprising:
a SIM card reader to which the SIM card is inserted; and
a remote interface transmitting the user identification information from the SIM card reader to the communication module according to control of the controller,
wherein the controller reads the user identification information from the SIM card inserted in the SIM card reader through the remote interface.

3. The computer system according to claim 1, wherein the communication module comprises a card connector to which the SIM card is detachably connected.

4. A method of controlling security of a computer system, comprising:
storing user identification information from a SIM card used to access a network;
reading the user identification information from the SIM card when the computer system is booted;
determining whether the user identification information stored in the SIM card is identical to the stored user identification information; and
allowing a user to access the computer system when the user identification information stored in the SIM card is identical to the stored user identification information.

5. The method according to claim 4, further comprising:
determining whether the SIM card is connected to the computer system; and
informing a user of absence of the SIM card when the SIM card is not connected to the computer system.

6. The computer system of claim 1, wherein an EPROM is the password storage.

7. The computer system of claim 1, wherein the controller is a BIOS.

8. The computer system of claim 1, further comprising a device interface interfacing with external devices and wherein the communication module is portable and in communication with the controller via the device interface.

9. The computer system of claim 1, wherein the network is a GSM network.

10. A computer system, comprising:
a password storage storing user identification information of a SIM card; and
a controller in communication with the SIM card and allowing access to the computer system upon booting of the computer system when the user identification information of the SIM card matches the user identification information stored in the password storage.

11. The computer system of claim 10, further comprising an interface interfacing with the SIM card and wherein the controller is in communication with the SIM card via the interface.

12. The computer system of claim 11, wherein the communication module accesses a GSM network.

13. The computer system of claim 11, wherein the interface is one or more of a PCI, a USB, a PCMCIA, and an ISA interface.

14. A secure computer system, comprising:
a SIM card communication module accessing a GSM network using user identification information of a SIM card; and
a controller in communication with the SIM card communication module and allowing access to the computer system based upon the user identification information of the SIM card.

15. A secure computer system, comprising:
storage means for storing user identification information of a SIM card; and
control means for communicating with the SIM card and for allowing access to the computer system upon booting of the computer system when the user identification information of the SIM card matches the user identification information stored in the storage means.

16. The secure computer system of claim 15, further comprising interface means for interfacing with the SIM card, wherein the control means communicates with the SIM card via the interface means.
